(19) United States
(12) Patent Application Publication
(10) Pub. No.: US 2025/0352417 A1
(43) Pub. Date: Nov. 20, 2025

(54) COMMODE HOLDER WITH REMOVABLE LINER FOR BEDBOUND PATIENTS

(71) Applicant: LampLight Innovations, Inc., Seattle, WA (US)

(72) Inventor: Naomi Ruth WEED, Seattle, WA (US)

(73) Assignee: LampLight Innovations, Inc., Seattle, WA (US)

(21) Appl. No.: 19/278,433

(22) Filed: Jul. 23, 2025

Related U.S. Application Data
(63) Continuation of application No. PCT/US2024/012943, filed on Jan. 25, 2024.
(60) Provisional application No. 63/481,434, filed on Jan. 25, 2023.

(51) Int. Cl. A61G 9/00; A61G 99/00

(52) U.S. Cl. CPC A61G 9/003; A61G 99/00; A61G 2200/327

(57) ABSTRACT

Disclosed herein are devices and methods for utilizing a portable bedpan for positioning patients. The portable bedpan can comprise a seat having a flat surface and a curved surface. The flat surface can comprise a seat opening in a center of the seat and one or more seat handle openings on opposite sides of the seat. The curved surface can be adjacent to the flat surface and can form a hollow interior. The flat surface can comprise one or more flanges within the hollow interior. The bedpan can further comprise a cartridge slidably coupled to the commode seat. The cartridge can be insertable through the one or more flanges. The bedpan can further comprise a liner removably coupled to the cartridge. The liner can be configured to hold fluid.

### CROSS-REFERENCE TO RELATED APPLICATION

This application is a continuation of International App. PCT/US2024/012943 filed Jan. 25, 2025, which claims the benefit of priority to U.S. Provisional Application No. 63/481,434, filed Jan. 25, 2023, which is incorporated by reference herein in its entirety.

### FIELD OF THE INVENTION

The present disclosure relates to systems for toileting and bathing bedbound patients.

### BACKGROUND OF THE INVENTION

One of the most frequent, challenging, and frustrating aspects of caring for mobility-impaired patients is the task of providing assistance with toileting. Some of the biggest complaints nurses and/or caregivers share regarding toileting mobility-impaired patients relate to: the amount of physical exertion required to maneuver the patient and the subsequent risk of personal injury due to the awkward body mechanics involved in physically lifting and turning patients, patients resistance or refusal to use the bed pan due to discomfort or the perceived loss of dignity, the risk of injury to patients due to inadvertently pulling on IV lines, tubes, etc. while turning and maneuvering the patient, or the patient falling while trying to get the patient out of bed, the high probability of spilling the contents while attempting to dislodge the bed pan from between the patient's backside and the mattress. Other challenges, especially with relatively weaker or larger patients, include, the number of staff members required to perform the task or the time spent waiting for help to arrive.

The bedpan is the current method for toileting bedbound patients. General bedpans are shallow, plastic pans for holding body waste. A brief description of the procedure is as follows: the patient is first laid flat on their back and turned onto their side, a hard plastic bedpan is wedged into the tight space between the bed and the patient's backside, and the patient is rolled onto the bed pan and sat up. After the patient is finished filling the bedpan: the patient is laid flat, turned onto their side such that the healthcare provider can attempt to dislodge the shallow excrement-filled pan from the patient's backside without spilling the contents. The healthcare provider then often has to clean up any spills, change the patient's bedding, and carry a shallow, excrement-filled pan to the dirty utility room at the end of a busy hallway for proper disposal. Since traditional bed pans can be awkward and uncomfortable, patients often refuse to use them, instead choosing to risk falling out of bed trying to make it to the bathroom in a weakened state.

Therefore, a need exists for a device and method for allowing bedbound patients to remain in a supine position while utilizing the support and adjustable mechanics of the gurney or hospital bed.

### SUMMARY

In one variation, a portable bedpan is disclosed. The portable bedpan can comprise a seat having a flat surface and a curved surface. The flat surface can comprise a seat opening in a center of the seat and one or more seat handle openings on opposite sides of the seat. The curved surface can be adjacent to the flat surface and can form a hollow interior. The flat surface can comprise one or more flanges within the hollow interior. The bedpan can further comprise a cartridge slidably coupled to the commode seat. The cartridge can be insertable through the one or more flanges. The cartridge can comprise a cartridge opening in fluid communication with the seat opening when the cartridge is coupled to the commode seat. The cartridge can comprise one or more cartridge handle openings on opposite sides of the seat. The one or more cartridge handle openings can align with the one or more seat handle openings when the cartridge is coupled to the seat. The bedpan can further comprise a liner removably coupled to the cartridge. The liner can be configured to hold fluid.

The cartridge can further be disposable or reusable. The line can be detachably coupled from the cartridge. The liner can be integral to the cartridge. The cartridge can be foldable at a center of the cartridge such that the one or more cartridge handle openings align with each other. The cartridge can be foldable at a first section of the cartridge and at a second section of the cartridge such that the one or more cartridge handle openings align with each other. A length of the seat can be about 24 inches. A height of the seat can be about 7 inches. A width of the seat can be about 13 inches. An edge between the flat surface and the curved surface can be rounded.

In other variations, a method of positioning a patient on a platform is disclosed herein. The method can comprise placing a portable bedpan underneath legs of the patient while the platform is in a flat configuration. The method can further comprise reclining the platform to an upright configuration.

### BRIEF DESCRIPTION OF THE DRAWINGS

FIG. 1A illustrates a perspective view of a seat according to one variation of the invention.

FIG. 1B illustrates a top view of a cartridge to be used with the seat of FIG. 1A.

FIG. 1C illustrates a side view of a liner to be coupled with the cartridge of FIG. 1B.

FIG. 1D illustrates a side view of a liner and a cartridge.

FIG. 2 illustrates a perspective view of the seat and the cartridge being coupled together.

FIGS. 3A and 3B illustrate side views of the seat in use with a patient laying on a platform.

FIGS. 3C and 3D illustrate side views of the seat in use with a patient seated on a reclining platform.

### DETAILED DESCRIPTION OF THE INVENTION

The devices and methods disclosed herein increase safety for patients and caregivers. For instance, fewer position changes are needed compared to a traditional bedpan or bedside commode, therefore reducing the risk of falls and opportunities for IV lines, tubes, monitors, etc. to become dislodged. The seat can also be sized such that it can fit underneath a bed or gurney, increasing the portability of the device. The seat also reduces the need for significant lifting of the patient, reducing injuries for the caregiver or patient as well as reducing the risk of spills and/or body fluid exposure.

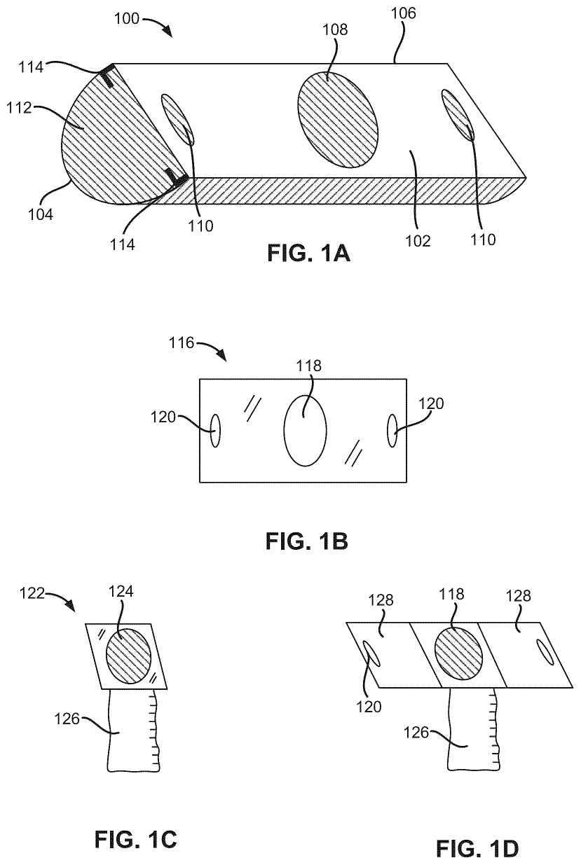

FIG. 1A illustrates a seat 100. The seat can have a flat surface 102 and a curved base 104 adjacent to the flat surface 102. The flat surface 102 and the curved base 104 can meet at an edge 106 along a perimeter of the flat surface 102. The edge 106 can be rounded, chamfered, or a corner (e.g., at a right angle).

The flat surface 102 can comprise a seat opening 108 in a center of the flat surface 102. The seat opening 108 can be oval shaped and can be sized to accommodate a patient such that waste can be disposed of through the opening while the patient is sitting on the seat. The seat opening can comprise a width of about 4 inches to about 7 inches (e.g., about 5.5 inches). The seat opening can comprise a length of about 7 inches to about 12 inches (e.g., about 10 inches). The seat opening 108 can comprise a rounded edge within the seat for comfort for the patient.

The curved base 104 can comprise a height of about 5 inches to about 9 inches (e.g., about 7 inches) extending from the flat surface 102 to an apex of the curved base 104. The curved base 104 can comprise a curvature configured to pivot when a patient sits on the seat 100 when the seat 100 is placed on a reclining platform (e.g., a hospital bed). As such, the curved base 104 can provide rotation points for the patient for when the patient is seated on the seat 100.

The flat surface 102 can have one or more handles 110 positioned on either side of the seat 100. The handles 110 can be configured as openings in the flat surface 102. The openings can be oval shaped and can have a length of about 2 inches to about 3 inches (e.g., about 2.5 inches). The handles 110 can be used by the patient or healthcare provider to carry or reposition the seat 100. In other variations, the handles 110 can comprise projections extending from the flat surface 102.

The seat 100 can comprise a hollow interior 112 and can be made of a suitable plastic that can tolerate bleach and other hospital disinfectants. Examples of materials that can be used include high-density polyethylene (HDPE) and polypropylene (PP), or a combination thereof.

One or more flanges 114 can be positioned underneath either side of the flat surface 102. The flanges 114 can comprise a bracket extending from a bottom of the flat surface 102 towards the curved base 104. The flanges 114 can be sized for insertion of a cartridge 116 into the hollow interior 112 of the seat, as will be described below. The flanges 114 can be positioned at ends of the width of the flat surface 102 or slightly within the width of the flat surface 102.

As seen in FIG. 1B, the cartridge 116 can be flat and can comprise a cartridge opening 118 and cartridge handle openings 120. The cartridge opening 118 can be sized to accommodate a patient such that waste can be disposed through the cartridge opening 118 while the patient is sitting on the seat 100. The cartridge opening 118 can be oval shaped and can be the same size or larger than the seat opening 108 to provide fluid communication therethrough. The cartridge handle openings 120 can be oval shaped and can be the same size or larger than the handle openings of the seat 100.

The cartridge 116 can be reusable and can be made of a suitable plastic that can tolerate bleach and other hospital disinfectants. Examples of materials that can be used include high-density polyethylene (HDPE) and polypropylene (PP), or a combination thereof. In some variations, the cartridge 116 can be disposable and can be made of cellulose-based material such as paper or cardboard. In some variations, the cartridge 116 can comprise rounded edges at its perimeter.

A liner 122, as seen in FIG. 1C, can be detachably coupled to the cartridge 116. The liner can have a flat piece comprising a liner opening 124 that is oval shaped and the same size or larger than the cartridge opening 118. The liner opening 124 can be coupled to a bag 126 to collect waste. The bag 126 can be used to hold about 500 ml to about 1 Liter of waste. The liner 122 can be attached to the cartridge 116 via an adhesive.

In some variations, the liner 122 can be integral with the cartridge 116. As seen in FIG. 1D, the cartridge 116 can comprise the liner 122. The cartridge 116 can have foldable flaps 128 that can comprise the cartridge handle openings 120. The cartridge 116 can be foldable at a center of the cartridge 116 such that the one or more cartridge handle openings 120 align with each other. In some variations, the cartridge 116 can be foldable at a first section of the cartridge and at a second section of the cartridge such that the one or more cartridge handle openings 120 align with each other.

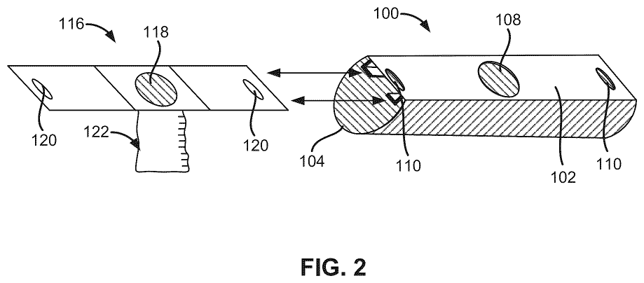

As seen in FIG. 2, the cartridge 116 can be inserted to the seat 100 by sliding the cartridge 116 through the curved base 104 via flanges 114 where the cartridge 116 can rest. The cartridge opening 118 can be aligned with the seat opening 108 and the cartridge handle openings can be aligned with the seat handles openings of the seat 100. The liner 122 can be already coupled to the cartridge 116 or can be attached to the cartridge 116 through the seat opening 108 when the cartridge 116 is coupled with the seat 100. The insertion and removal of the cartridge 116 can be used while a patient is sitting on the seat 100.

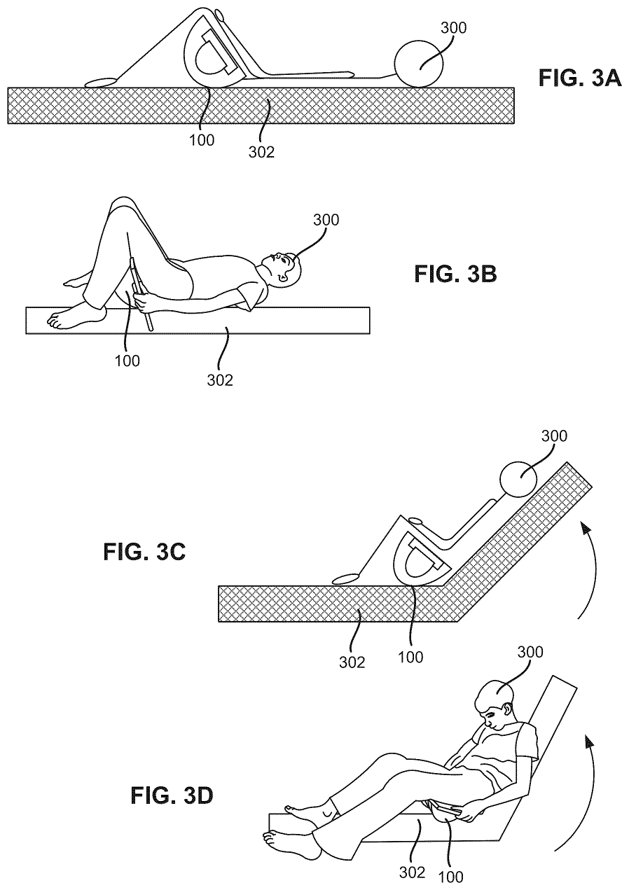

FIGS. 3A and 3B illustrate the seat 100 and the cartridge 116 placed beneath a patient 300 when the patient 300 is in the supine position on a platform 302 (e.g., a hospital bed) in a flat configuration. The patient 300 can have their knees lifted and the seat 100 placed underneath their knees. The cartridge 116 can be coupled to the seat 100 prior to placing the seat 100 beneath the patient 300. Alternatively, the cartridge 116 can also be coupled to the seat 100 after the seat 100 is under the patient 300. The seat 100 can provide a smooth and comfortable surface for the patient 300 when in use, as well as rotation to adjust the patient 300 as needed.

FIGS. 3C and 3D illustrate the platform 302 being raised to an upright configuration such that the patient 300 is pivoted via the seat 100 and thus sitting. The seat 100 can support a patient of up to 700 lbs in this configuration. The curved base 104 allows the seat 100 to roll and accommodate a wide range of positions, from the patient 300 laying flat at 180 degrees to sitting up at 90 degrees. The patient can use the seat 100 for toileting through the seat opening 108 and into the liner 122. When the patient is finished, the healthcare provider can remove the cartridge 116 from the seat 100 while the seat 100 is in an upright position, preventing spills.

A number of embodiments have been described. Nevertheless, it will be understood by one of ordinary skill in the art that various changes and modifications can be made to this disclosure without departing from the spirit and scope of the embodiments. Elements of systems, devices, apparatus, and methods shown with any embodiment are exemplary for the specific embodiment and can be used in combination or otherwise on other embodiments within this disclosure. For example, the steps of any methods depicted in the figures or described in this disclosure do not require the particular order or sequential order shown or described to achieve the desired results. In addition, other steps or operations may be provided, or steps or operations may be eliminated or omitted from the described methods or processes to achieve the desired results. Moreover, any components or parts of any apparatus or systems described in this disclosure or depicted in the figures may be removed, eliminated, or omitted to achieve the desired results. In addition, certain components or parts of the systems, devices, or apparatus shown or described herein have been omitted for the sake of succinctness and clarity.

Accordingly, other embodiments are within the scope of the following claims and the specification and/or drawings may be regarded in an illustrative rather than a restrictive sense.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit, or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein. For example, a description of a range from 1 to 5 should be considered to have disclosed subranges such as from 1 to 3, from 1 to 4, from 2 to 4, from 2 to 5, from 3 to 5, etc. as well as individual numbers within that range, for example 1.5, 2.5, etc. and any whole or partial increments therebetween.

All existing subject matter mentioned herein (e.g., publications, patents, patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

Reference to the phrase “at least one of”, when such phrase modifies a plurality of items or components (or an enumerated list of items or components) means any combination of one or more of those items or components. For example, the phrase “at least one of A, B, and C” means: (i) A; (ii) B; (iii) C; (iv) A, B, and C; (v) A and B; (vi) B and C; or (vii) A and C.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” “element,” or “component” when used in the singular can have the dual meaning of a single part or a plurality of parts. As used herein, the following directional terms “forward, rearward, above, downward, vertical, horizontal, below, transverse, laterally, and vertically” as well as any other similar directional terms refer to those positions of a device or piece of equipment or those directions of the device or piece of equipment being translated or moved.

Finally, terms of degree such as “substantially”, “about” and “approximately” as used herein mean the specified value or the specified value and a reasonable amount of deviation from the specified value (e.g., a deviation of up to +0.1%, +1%, +5%, or +10%, as such variations are appropriate) such that the end result is not significantly or materially changed. For example, “about 1.0 cm” can be interpreted to mean “1.0 cm” or between “0.9 cm and 1.1 cm.” When terms of degree such as “about” or “approximately” are used to refer to numbers or values that are part of a range, the term can be used to modify both the minimum and maximum numbers or values.

It will be understood by one of ordinary skill in the art that the various methods disclosed herein may be embodied in a non-transitory readable medium, machine-readable medium, and/or a machine accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

1. A portable bedpan, comprising:
a seat having a flat surface and a curved surface, wherein the flat surface comprises a seat opening in a center of the seat and one or more seat handle openings on opposite sides of the seat, wherein the curved surface is adjacent to the flat surface and forms a hollow interior, wherein the flat surface comprises one or more flanges within the hollow interior;
a cartridge slidably coupled to the commode seat, the cartridge being insertable through the one or more flanges, wherein the cartridge comprises a cartridge opening in fluid communication with the seat opening when the cartridge is coupled to the commode seat, wherein the cartridge comprises one or more cartridge handle openings on opposite sides of the seat, wherein the one or more cartridge handle openings align with the one or more seat handle openings when the cartridge is coupled to the seat; and
a liner removably coupled to the cartridge, wherein the liner is configured to hold fluid.

2. The portable bedpan of claim 1, wherein the cartridge is disposable.

3. The portable bedpan of claim 1, wherein the cartridge is reusable.

4. The portable bedpan of claim 1, wherein the liner is detachably coupled from the cartridge.

5. The portable bedpan of claim 1, wherein the liner and the cartridge are integral to each other.

6. The portable bedpan of claim 1, wherein the cartridge is foldable at a center of the cartridge such that the one or more cartridge handle openings align with each other.

7. The portable bedpan of claim 1, wherein the cartridge is foldable at a first section of the cartridge and at a second section of the cartridge such that the one or more cartridge handle openings align with each other.

8. The portable bedpan of claim 1, wherein a length of the seat is 24 inches, a height of the seat is 7 inches, and a width of the seat is 13 inches.

9. The portable bedpan of claim 1, wherein an edge between the flat surface and the curved surface is rounded.

10. A method of positioning a patient on a platform, the method comprising:
placing a portable bedpan underneath legs of the patient while the platform is in a flat configuration, the portable bedpan comprising:
a seat having a flat surface and a curved surface, wherein the flat surface comprises a seat opening in a center of the seat and one or more seat handle openings on opposite sides of the seat, wherein the curved surface is adjacent to the flat surface and forms a hollow interior, wherein the flat surface comprises one or more flanges within the hollow interior;
a cartridge slidably coupled to the commode seat, the cartridge being insertable through the one or more flanges, wherein the cartridge comprises a cartridge opening in fluid communication with the seat opening when the cartridge is coupled to the commode seat, wherein the cartridge comprises one or more cartridge handle openings on opposite sides of the seat, wherein the one or more cartridge handle openings align with the one or more seat handle openings when the cartridge is coupled to the seat; and
a liner removably coupled to the cartridge, wherein the liner is configured to hold fluid;
reclining the platform to an upright configuration.

11. The method of claim 10, wherein the cartridge is disposable.

12. The method of claim 10, wherein the cartridge is reusable.

13. The method of claim 10, wherein the liner is detachably coupled from the cartridge.

14. The method of claim 10, wherein the liner and the cartridge are integral to each other.

15. The method of claim 10, wherein the cartridge is foldable at a center of the cartridge such that the one or more cartridge handle openings align with each other.

16. The method of claim 10, wherein the cartridge is foldable at a first section of the cartridge and at a second section of the cartridge such that the one or more cartridge handle openings align with each other.

17. The method of claim 10, wherein a length of the seat is 24 inches, a height of the seat is 7 inches, and a width of the seat is 13 inches.

18. The method of claim 10, wherein an edge between the flat surface and the curved surface is rounded.
